(19) United States
(12) Patent Application Publication
(10) Pub. No.: US 2024/0190208 A1
(43) Pub. Date: Jun. 13, 2024

(54) VEHICULAR AIR CONDITIONING SYSTEM

(71) Applicants: Hanon Systems, Daejeon (KR); ONE GENE ELECTRONICS CO., LTD, Gyeonggi-do (KR)

(72) Inventors: Sang Ho OH, Daejeon (KR); Chae Geun LIM, Daejeon (KR); Du Yeong KIM, Gyeonggi-do (KR)

(21) Appl. No.: 18/285,737

(22) PCT Filed: Apr. 7, 2022
(86) PCT No.: PCT/KR2022/005044

§ 371 Date: Oct. 5, 2023

(30) Foreign Application Priority Data
Apr. 14, 2021 (KR) 10-2021-0048338

(51) Int. Cl. B60H 1/00; G01K 1/14

(52) U.S. Cl. CPC B60H 1/00792; G01K 1/14; G01K 2201/02

(57) ABSTRACT

A vehicular air conditioning system includes an outdoor air sensor configured to detect outside of the vehicle. The outdoor air sensor includes a sensor body portion having a sensing portion and a terminal portion, a fixing portion installed integrally with the sensor body portion so as to fixedly assemble the sensor body portion to the vehicle body, and a correct assembly guide portion configured to guide the sensor body portion so that the sensor body portion can be correctly assembled to the vehicle body at a predetermined angular position when the sensor body portion is fixed and assembled to the vehicle body.

### TECHNICAL FIELD

The present invention relates to a vehicular air conditioning system, and more particularly, a vehicular air conditioning system capable of enabling an outdoor air sensor to be easily assembled on a vehicle body without having to use a separately manufactured fixing hook, and capable of preventing foreign substances from entering a connection portion between an outdoor air sensor terminal and an electrical connector so as to prevent corrosion of the outdoor air sensor terminal and the electrical connector due to the entry of foreign substances, the resultant sensing errors, and the malfunction and damage of the outdoor air sensor.

### BACKGROUND ART

Recently, a vehicular air conditioning system has been upgraded to an automatic control type.

The automatic control type air conditioning system detects a vehicle interior temperature, a vehicle exterior temperature, a solar radiation and the like, and then automatically adjusts the vehicle interior temperature according to the detected data, thereby constantly maintaining the vehicle interior temperature at a comfortable temperature.

Meanwhile, such an automatic control type air conditioning system (hereinafter abbreviated as “air conditioning system”) is essentially provided with an outdoor air sensor for detecting a vehicle exterior temperature.

As shown in FIGS. 1 and 2, the outdoor air sensor includes a sensor body 1 and a fixing hook 5 for fixing the sensor body 1 to a vehicle body 3.

The sensor body 1 is provided with a thermistor 1a and a terminal 1b. In particular, the thermistor 1a is a structure encapsulated by a plastic molding 1c, and is configured to protrude from one side of the sensor body 1 toward the outside of the vehicle to detect the vehicle exterior temperature.

The fixing hook 5 is fixedly assembled on one side of the sensor body 1 and is provided with a pair of hook wings 5a.

This fixing hook 5 is configured to be fitted and coupled to a fixing hole 3a formed in the vehicle body 3. The fixing hook 5 configured in this way fixes the sensor body 1 to the vehicle body 3.

However, in this conventional outdoor air sensor, the fixing hook 5 for fixing the sensor body 1 to the vehicle body 3 needs to be manufactured separately, and needs to be individually assembled to the sensor body 1. Therefore, the manufacturing cost and the assembly process are increased, and the manufacturing efficiency is decreased.

In addition, the conventional outdoor air sensor has a structure in which the entire sensor body 1 is exposed to the outside of the vehicle, and is therefore vulnerable to external foreign substances such as moisture and dust.

In particular, the terminal 1b of the sensor body 1 and the electrical connector (not shown) connected thereto are exposed to the outside of the vehicle. Therefore, various foreign substances existing outside the vehicle may enter the connection portion between the terminal 1b and the electrical connector.

Further, the terminal 1b and the electrical connector are corroded, which may cause poor connection between the terminal 1b and the electrical connector. As a result, errors may occur in the transmission of a sensing value of the thermistor 1a.

In addition, the outdoor air sensor may be broken or damaged due to the corrosion of the terminal 1b and the electrical connector.

### SUMMARY

In view of the problems inherent in the related art, it is an object of the present invention to provide a vehicular air conditioning system capable of enabling an outdoor air sensor to be easily assembled on a vehicle body without having to use a separately manufactured fixing hook.

Another object of the present invention is to provide a vehicular air conditioning system capable of significantly reducing the cost and man-hours required to manufacture a separate fixing hook and assemble the fixing hook to the outdoor air sensor.

A further object of the present invention is to provide a vehicular air conditioning system capable of preventing foreign substances from entering a connection portion between a terminal of an outdoor air sensor and an electrical connector through structural improvement.

A still further object of the present invention is to provide a vehicular air conditioning system capable of preventing corrosion of a terminal and an electrical connector due to the entry of foreign substances into a connection portion between the terminal and the electrical connector, the resultant sensing errors, and the failure and damage of the outdoor air sensor.

In order to achieve these objects, there is provided a vehicular air conditioning system, including: an outdoor air sensor configured to detect a temperature outside a vehicle interior, wherein the outdoor air sensor includes a sensor body portion having a sensing portion and a terminal portion, a fixing portion installed integrally with the sensor body portion so as to fixedly assemble the sensor body portion to the vehicle body, and a correct assembly guide portion configured to guide the sensor body portion so that the sensor body portion can be correctly assembled to the vehicle body at a predetermined angular position when the sensor body portion is fixed and assembled to the vehicle body.

The sensing portion may be formed on one side of the sensor body portion, the terminal portion may be formed on the other side of the sensor body portion, a portion of the sensor body portion on the sensing portion side may be fitted into a fixing hole of the vehicle body, and the fixing portion may be configured to fixedly assemble the sensor body portion to the fixing hole of the vehicle body so that the sensing portion on one side with respect to the fixing hole of the vehicle body faces a vehicle exterior side while the terminal portion on the other side with respect to the fixing hole of the vehicle body faces an engine room side.

The fixing portion may include a plurality of elastic hooks provided on the sensor body portion at predetermined intervals along a concentric circle centered on the sensing portion, the elastic hooks may be elastically deformed radially inward while being inserted into the fixing hole together with the sensing portion when the sensing portion of the sensor body portion is fitted into the fixing hole of the vehicle body, and hook portions at the ends of the elastic hooks passed through the fixing hole may be restored radially outward and locked to the portion of the vehicle body around the fixing hole on the vehicle exterior side to fix the sensor body portion to the fixing hole of the vehicle body.

The fixing portion may further include a plurality of support ribs formed on portions of the sensor body portion corresponding to the elastic hooks with the fixing hole of the vehicle body interposed therebetween, and the support ribs may be supported on both sides of the vehicle body while facing the elastic hooks with the fixing hole interposed therebetween, so that the sensor body portion are fixedly supported on the vehicle body.

The correct assembly guide portion may include a correct assembly groove formed at an angular position of the fixing hole of the vehicle body, and a correct assembly protrusion formed on the sensor body portion so that the correct assembly protrusion can be fitted and coupled to the correct assembly groove, and the correct assembly protrusion may be formed so that when the sensor body portion is correctly assembled into the fixing hole of the vehicle body at a predetermined angular position, the correct assembly protrusion is aligned with and fitted to the correct assembly groove to permit assembly of the sensor body portion into the fixing hole of the vehicle body, and when the sensor body portion is incorrectly assembled into the fixing hole of the vehicle body at a position offset from the predetermined angular position, the correct assembly protrusion is misaligned with the correct assembly groove to restrict assembly of the sensor body portion into the fixing hole of the vehicle body.

The system may further include: a foreign substance entry preventing portion configured to prevent foreign substances from entering the terminal portion side of the sensor body portion from the vehicle exterior side.

According to the vehicular air conditioning system of the present invention, the fixing portion for fixing the outdoor air sensor to the vehicle body is formed integrally with the outdoor air sensor. This enables the outdoor air sensor to be easily assembled on the vehicle body without having to use a separately manufactured fixing hook.

Since the outdoor air sensor can be easily assembled on the vehicle body without having to use a separately manufactured fixing hook, it is possible to significantly reduce the cost and man-hours required to manufacture a separate fixing hook and assemble the fixing hook to the outdoor air sensor.

In addition, since the correct assembly guide portion is formed at the assembly location of the outdoor air sensor and the vehicle body to assure the correct assembly of the outdoor air sensor to the vehicle body, when assembling the outdoor air sensor to the vehicle body, it is possible to accurately and easily assemble the outdoor air sensor to the vehicle body at a predetermined angular position.

In addition, since the entry of foreign substances into the connection portion between the terminal of the outdoor air sensor and the electrical connector is prevented by forming the foreign substance entry preventing portion in the outdoor air sensor, it is possible to prevent corrosion of the terminal and the electrical connector due to the entry of foreign substances into the connection portion between the terminal and the electrical connector, the resultant sensing errors, and the failure and damage of the outdoor air sensor.

### BRIEF DESCRIPTION OF THE DRAWINGS

FIG. 1 is a perspective view showing an outdoor air sensor that constitutes a conventional vehicular air conditioning system.

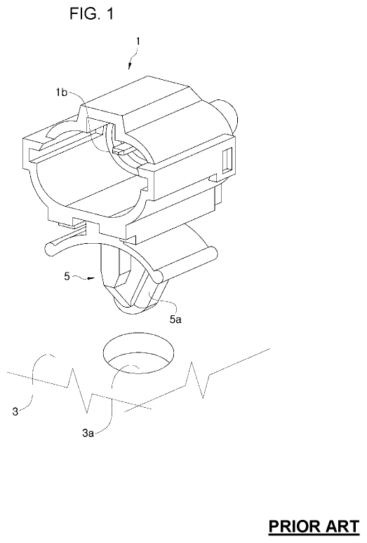

FIG. 2 is a cross-sectional view showing an outdoor air sensor that constitutes the conventional vehicular air conditioning system.

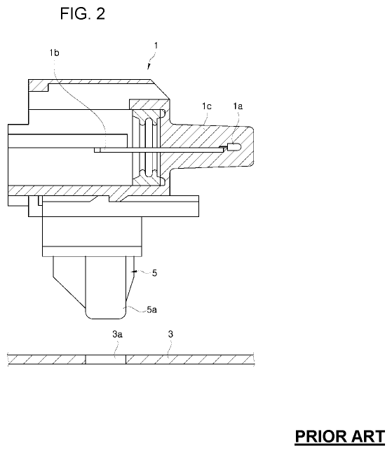

FIG. 3 is a view showing an outdoor air sensor that constitutes a vehicular air conditioning system according to the present invention, and is an exploded perspective view showing the outdoor air sensor before it is installed on the vehicle body.

FIG. 4 is an exploded perspective view showing the outdoor air sensor of the vehicular air conditioning system according to the present invention installed on the vehicle body.

FIG. 5 is a cross-sectional view taken along line V-V in FIG. 4.

FIG. 6 is a cross-sectional view taken along line VI-VI in FIG. 4.

### DETAILED DESCRIPTION

A preferred embodiment of a vehicular air conditioning system according to the present invention will now be described in detail with reference to the accompanying drawings.

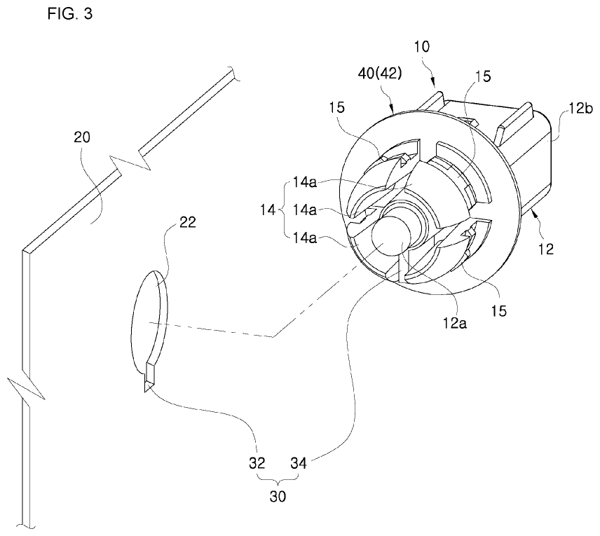

Referring to FIGS. 3 to 6, the vehicular air conditioning system of the present invention includes an outdoor air sensor 10 that detects a temperature outside a vehicle interior.

The outdoor air sensor 10 includes a sensor body portion 12 and a fixing portion 14 for fixing the sensor body portion 12 to a fixing hole 22 of a vehicle body 20.

The sensor body portion 12 includes a sensing portion 12a at the front and a terminal portion 12b at the rear.

The sensing portion 12a includes a thermistor 12a-1 and a plastic molding 12a-2 that protrudes long from the sensor body portion 12 toward the front while surrounding the thermistor 12a-1.

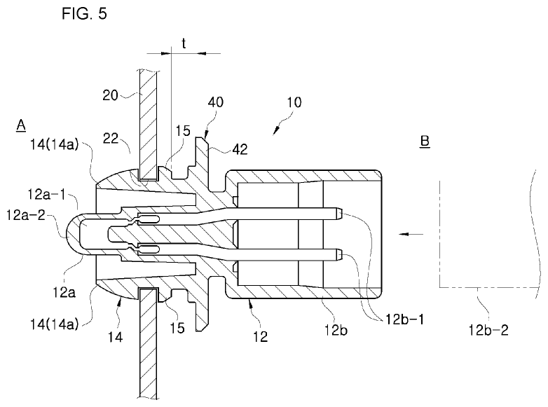

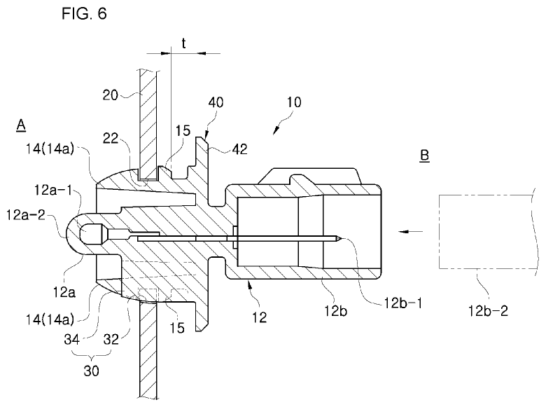

As shown in FIGS. 5 and 6, when the sensor body portion 12 is fixedly installed in the fixing hole 22 of the vehicle body 20, the sensing portion 12a passes through the fixing hole 22 and face the vehicle exterior side (A). The sensing portion 12a configured in this way detects outside temperature of the vehicle.

The terminal portion 12b includes a pair of terminals 12b-1 electrically connected to the thermistor 12a-1, and is configured to be connected to an electrical connector 12b-2 on the vehicle control unit side.

This terminal portion 12b is configured to face an engine room side (B) of the vehicle when the sensor body portion 12 is fixedly installed in the fixing hole 22 of the vehicle body 20. The terminals 12b-1 configured in this way transmits the outdoor temperature data sensed by the thermistor 12a-1 to a vehicle control unit.

Referring again to FIGS. 3 to 6, the fixing portion 14 includes a plurality of elastic hooks 14a installed at regular intervals on the sensor body portion 12 around the sensing portion 12a.

The elastic hooks 14a are installed on the sensor body portion 12 around the sensing portion 12a, and are installed at regular intervals along a concentric circle centered on the sensing portion 12a.

The elastic hooks 14a are in contact with the inner peripheral surface of the fixing hole 22 and are elastically deformed radially inward when assembling the sensing portion 12a of the sensor body portion 12 into the fixing hole 22 of the vehicle body 20.

The elastic hooks 14a elastically deformed in this way pass through the fixing hole 22. Then, the hook portions at the ends of the elastic hooks 14a are restored radially outward and locked to the portion of the vehicle body 22 around the fixing hole 22 on the vehicle exterior side (A).

The elastic hooks 14a locked to the vehicle body 20 around the fixing hole 22 fixedly secure the sensor body portion 12 to the vehicle body 20. In particular, the sensing portion 12a is fixedly installed on the vehicle body 20 so as to face the vehicle exterior side (A).

In this regard, it is preferable that four elastic hooks 14a are installed at regular intervals along a concentric circle centered on the sensing portion 12a.

In addition, the elastic hooks 14a are integrally injection-molded with the sensor body portion 12 when the sensor body portion 12 is manufactured by injection molding.

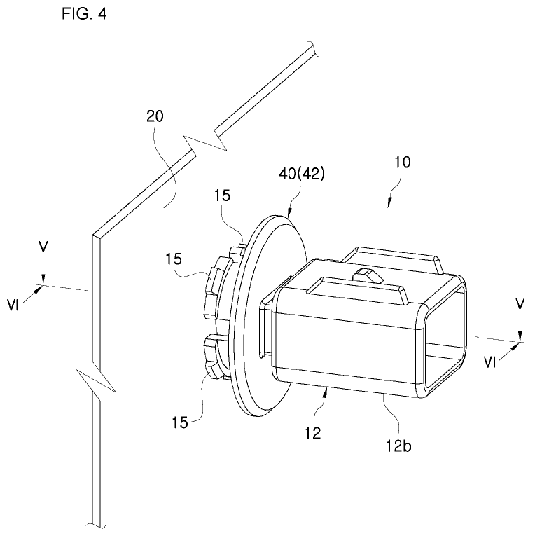

Meanwhile, as shown in FIGS. 4 to 6, a plurality of support ribs is installed on the sensor body portion 12 corresponding to the elastic hooks 14a with the fixing hole 22 of the vehicle body 20 interposed therebetween.

The support ribs 15 is configured to be supported on the portion of the vehicle body 20 on the opposite side of the fixing hole 22, i.e., the portion of the vehicle body 20 on the engine room side (B) when the elastic hooks 14a are locked supported by the portion of vehicle body 20 on the vehicle exterior side (A) around the fixing hole 22.

Accordingly, the sensor body portion 12 is supported on the vehicle body 20 while facing the elastic hooks 14a with the fixing hole 22 interposed therebetween. As a result, the sensor body portion 12 is firmly installed on the vehicle body 20.

In this regard, the support ribs 15 are integrally injection-molded with the sensor body portion 12 when the sensor body portion 12 is manufactured by injection molding.

Referring again to FIGS. 3 to 6, the vehicular air conditioning system further includes a correct assembly guide portion 30 configured to guide the sensor body portion 12 so that the sensor body portion 12 can be correctly assembled into the fixing hole 22 of the vehicle body 20 at a predetermined angular position when the sensor body portion 12 is fixed and assembled to the fixing hole 22 of the vehicle body 20.

The correct assembly guide portion 30 includes a correct assembly groove 32 formed at an angular position of the fixing hole 22 of the vehicle body 20, and a correct assembly protrusion 34 formed in the sensor body portion 12 so as to be fitted into the correct assembly groove 32.

In particular, the correct assembly protrusion 34 is formed so that when the sensor body portion 12 is correctly assembled into the fixing hole 22 of the vehicle body 20 at a predetermined angular position, the correct assembly protrusion 34 can be fitted and coupled to the correct assembly groove 32.

Accordingly, the assembly of the sensor body portion 12 into the fixing hole 22 of the vehicle body 20 is permitted.

Conversely, when the sensor body portion 12 is incorrectly assembled into the fixing hole 22 of the vehicle body 20 at a position offset from the predetermined angular position, the correct assembly protrusion 34 on 34 is misaligned with the correct assembly groove 32.

In particular, when the sensor body portion 12 is incorrectly assembled into the fixing hole 22, the correct assembly protrusion 34 is misaligned with the correct assembly groove 32 of the fixing hole 22, thereby interfering with the surrounding vehicle body 20 so as to fundamentally restrict entry of the sensor body portion 12 into the fixing hole 22.

Accordingly, the assembly of the sensor body portion 12 to the fixing hole 22 of the vehicle body 20 is fundamentally restricted.

In this regard, the correct assembly groove 32 and the correct assembly protrusion 34 of the correct assembly guide portion 30 are coupled to each other when the sensor body portion 12 is correctly assembled into the fixing hole 22 of the vehicle body 20. Therefore, the correct assembly guide portion 30 also serves to prevent rotation of the sensor body portion 12, which is correctly assembled into the fixing hole 22 of the vehicle body 20.

Accordingly, the sensor body portion 12 correctly assembled into the fixing hole 22 of the vehicle body 20 is always maintained and fixed in a correctly assembled position.

Referring again to FIGS. 3 to 6, the outdoor air sensor 10 of the present invention further includes a foreign substance entry preventing portion 40 that prevents foreign substances from entering the terminal portion 12b of the sensor body portion 12 from the vehicle exterior side (A).

The foreign substance entry preventing portion 40 includes a foreign substance blocking plate 42 formed on the outer surface of the sensor body portion 12 between the sensing portion 12a and the terminal portion 12b.

The foreign substance blocking plate 42 is formed on the outer surface portion of the sensor body portion 12 between the sensing portion 12a and the terminal portion 12b on the engine room side (B) with respect to the fixing hole 22 of the vehicle body 20. In particular, the foreign substance blocking plate 42 is formed in a disk shape on the outer surface of the sensor body portion 12 on the engine room side (B).

This foreign substance blocking plate 42 blocks foreign substances flowing into the terminal portion 12b of the sensor body portion 12 from the vehicle exterior side (A).

In particular, during the vehicle washing process or during rainy weather, high-pressure moisture and foreign substances existing vehicle exterior side (A) may pass through the fixing hole 22 of the vehicle body 20 and may reach the terminal portion 12b of the sensor body portion 12. The foreign substance blocking plate 42 can block the moisture and foreign substances.

Accordingly, it is possible to prevent corrosion of the terminal portion 12b and the electrical connector 12b-2 due to the entry of moisture and foreign substances, the resultant sensing errors, and the failure and damage to the outdoor air sensor.

Meanwhile, the foreign substance blocking plate 42 is configured to be injection-molded integrally with the sensor body portion 12 when the sensor body portion 12 is manufactured by injection molding.

In addition, the disc-shaped foreign substance blocking plate 42 has a diameter larger than the diameter of the fixing hole 22 of the vehicle body 20.

In addition, the foreign substance blocking plate 42 is formed on the outer surface of the sensor body portion 12 on the engine room side (B) with respect to the fixing hole 22 of the vehicle body 20, and has the fixing hole 22 at a predetermined interval from the fixing hole 22.

Preferably, as shown in FIGS. 5 and 6, the foreign substance blocking plate 42 may be formed at a predetermined distance t from the support ribs 15 of the sensor body portion 12 supported on a portion of the vehicle body 20 around the fixing hole 22 on the engine room side (B).

According to the vehicular air conditioning system of the present invention described above, the fixing portion 14 for fixing the outdoor air sensor 10 to the vehicle body 20 is formed integrally with the outdoor air sensor 10. This enables the outdoor air sensor 10 to be easily assembled on the vehicle body 20 without having to use a separately manufactured fixing hook.

Since the outdoor air sensor 10 can be easily assembled on the vehicle body 20 without having to use a separately manufactured fixing hook, it is possible to significantly reduce the cost and man-hours required to manufacture a separate fixing hook and assemble the fixing hook to the outdoor air sensor 10.

In addition, since the correct assembly guide portion 30 is formed at the assembly location of the outdoor air sensor 10 and the vehicle body 20 to assure the correct assembly of the outdoor air sensor 10 to the vehicle body 20, when assembling the outdoor air sensor 10 to the vehicle body 20, it is possible to accurately and easily assemble the outdoor air sensor 10 to the vehicle body 20 at a predetermined angular position.

In addition, since the entry of foreign substances into the connection portion between the terminal portion 12b of the outdoor air sensor 10 and the electrical connector 12b-2 is prevented by forming the foreign substance entry preventing portion 40 in the outdoor air sensor 10, it is possible to prevent corrosion of the terminal portion 12b and the electrical connector 12b-2 due to the entry of foreign substances into the connection portion between the terminal portion 12b and the electrical connector 12b-2, the resultant sensing errors, and the failure and damage of the outdoor air sensor 10.

While the preferred embodiments of the present invention have been described above, the present invention is not limited to the above-described embodiments. Various modifications and changes may be made without departing from the scope and spirit of the present invention defined in the claims.

1. A vehicular air conditioning system, comprising:
an outdoor air sensor configured to detect outside temperature of the vehicle,
wherein the outdoor air sensor includes a sensor body portion having a sensing portion and a terminal portion, a fixing portion installed integrally with the sensor body portion so as to fixedly assemble the sensor body portion to the vehicle body, and a correct assembly guide portion configured to guide the sensor body portion so that the sensor body portion can be correctly assembled to the vehicle body at a predetermined angular position when the sensor body portion is fixed and assembled to the vehicle body.

2. The system of claim 1, wherein the sensing portion is formed on one side of the sensor body portion, the terminal portion is formed on the other side of the sensor body portion, a portion of the sensor body portion on the sensing portion side is fitted into a fixing hole of the vehicle body, and the fixing portion is configured to fixedly assemble the sensor body portion to the fixing hole of the vehicle body so that the sensing portion on one side with respect to the fixing hole of the vehicle body faces a vehicle exterior side while the terminal portion on the other side with respect to the fixing hole of the vehicle body faces an engine room side.

3. The system of claim 2, wherein the fixing portion includes a plurality of elastic hooks provided on the sensor body portion at predetermined intervals along a concentric circle centered on the sensing portion,
the elastic hooks are elastically deformed radially inward while being inserted into the fixing hole together with the sensing when the sensing portion of the sensor body portion is fitted into the fixing hole of the vehicle body, and
hook portions at the ends of the elastic hooks passed through the fixing hole are restored radially outward and locked to the portion of the vehicle body around the fixing hole on the vehicle exterior side to fix the sensor body portion to the fixing hole of the vehicle body.

4. The system of claim 3, wherein the fixing portion further includes a plurality of support ribs formed on portions of the sensor body portion corresponding to the elastic hooks with the fixing hole of the vehicle body interposed therebetween, and
the support ribs are supported on both sides of the vehicle body while facing the elastic hooks with the fixing hole interposed therebetween, so that the sensor body portion are fixedly supported on the vehicle body.

5. The system of claim 4, wherein the correct assembly guide portion includes a correct assembly groove formed at an angular position of the fixing hole of the vehicle body, and a correct assembly protrusion formed on the sensor body portion so that the correct assembly protrusion can be fitted and coupled to the correct assembly groove, and
the correct assembly protrusion is formed so that when the sensor body portion is correctly assembled into the fixing hole of the vehicle body at a predetermined angular position, the correct assembly protrusion is aligned with and fitted to the correct assembly groove to permit assembly of the sensor body portion into the fixing hole of the vehicle body, and when the sensor body portion is incorrectly assembled into the fixing hole of the vehicle body at a position offset from the predetermined angular position, the correct assembly protrusion is misaligned with the correct assembly groove to restrict assembly of the sensor body portion into the fixing hole of the vehicle body.

6. The system of claim 1, further comprising:
a foreign substance entry preventing portion configured to prevent foreign substances from entering the terminal portion side of the sensor body portion from the vehicle exterior side.

7. The system of claim 6, wherein the foreign substance entry preventing portion includes a foreign substance blocking plate formed on an outer surface portion of the sensor body portion between the sensing portion and the terminal portion to block foreign substances entering the terminal portion side of the sensor body portion from the vehicle exterior side.

8. The system of claim 7, wherein the foreign substance blocking plate is formed in a disk shape on the outer surface portion of the sensor body portion between the sensing portion and the terminal portion on the engine room side with respect to the fixing hole of the vehicle body so as to block foreign substances passing through the fixing hole of the vehicle body and entering the terminal portion side of the sensor body portion.

9. The system of claim 8, wherein the foreign substance blocking plate has a diameter larger than a diameter of the fixing hole of the vehicle body.

10. The system of claim 9, wherein the foreign substance blocking plate is formed on the outer surface portion of the sensor body portion on the engine room side with respect to the fixing hole of the vehicle body at a predetermined interval from the fixing hole.

11. The system of claim 10, wherein the foreign substance blocking plate is formed at a predetermined interval from support ribs of the sensor body portion supported on a portion of the vehicle body around the fixing hole.
